(19) United States
(12) Patent Application Publication
(10) Pub. No.: US 2008/0111283 A1
(43) Pub. Date: May 15, 2008

(54) METHOD AND A TOOL FOR SHAPING AN ELONGATED DEFORMABLE MEMBER FOR A HEARING AID

(75) Inventors: Christian Bohl Espersen, Ballerup (DK); Jan Topholm, Holte (DK); Jorgen Mejner Olsen, Hillerod (DK)

Correspondence Address: SUGHRUE MION, PLLC, 2100 PENNSYLVANIA AVENUE, N.W., SUITE 800, WASHINGTON, DC, 20037, US

(73) Assignee: Widex A/S, Varlose (DK)

(21) Appl. No.: 11/960,693

(22) Filed: Dec. 19, 2007

Related U.S. Application Data
(63) Continuation-in-part of application No. PCT/DK2005/000430, filed on Jun. 27, 2005.

(51) Int. Cl. B29C 33/38; B29C 53/08; B29C 67/00; B29D 23/00; H04R 31/00

(52) U.S. Cl. 264/401; 264/497; 264/219; 264/222; 264/229; 425/323; 428/34.1

(57) ABSTRACT

A tool (20) and a method for shaping an elongated deformable member for a hearing aid (1). The tool is manufactured using a rapid prototyping process. The tool comprises a first holding means (21) for a first end of the elongated member, a second holding means (31) for holding a second end of the elongated member, and positioning means (26,28) for positioning and holding intermediate parts of said elongated member between said first end and said second end in a fixed desired shape. The shaping a of the deformable elongated member comprises the steps of placing the first end of the elongated member in a predetermined position, positioning said intermediate parts of said elongated member in a predetermined position, placing the second end of the elongated member in a predetermined position, heating said elongated member, and cooling said elongated member.

### RELATED APPLICATIONS

The present application is a continuation-in-part of application No. PCT/DK2005/000430; filed on 27 Jun. 2005, in Denmark and published as WO 2007/000160A1.

### BACKGROUND OF THE INVENTION

### Field of the Invention

The present invention relates to a method and a tool for shaping an elongated deformable member for a hearing aid, as well as to a method for a tool for shaping an elongated member.

BTE-type hearing aids generally have a hearing aid housing comprising a hard shell in which all of the electronics, including input and output transducers, of the hearing aid are typically located. The hard shell is worn Behind The Ear, hence the abbreviation BTE. As the output transducer is located in the hearing aid housing, the output sound from the hearing aid is conducted via a sound tube to an earplug placed in an ear of the person wearing the hearing aid. Both the sound tube and the earplug constitute replaceable parts, which can be, and normally are, replaced with regular intervals. The sound tube is typically replaced less frequently than the earplug, because it is less prone to be soiled, e.g. by cerumen.

The sound tube has to have a three dimensional curvature in order to allow the sound tube to fit the hearing aid housing at its first end whilst allowing the other end, to which the ear plug is attached, to point in a direction into the ear canal together with the ear plug.

In order to attach the first and second ends of the sound tube to the hearing aid housing and earplug, respectively, both ends are provided with connection means. These connection means are normally provided by insert moulding around the respective ends of a length of tube. The tube is normally prefabricated in long lengths in a continuous process such as extrusion, and the desired length of tube is cut from this long length. The actual length of the desired length of tube depends on the user for which the resulting sound tube is intended. Even though the actual length of the desired length of tube depends on the user, usually only a few standard lengths are used, e.g. three. This is sufficient because differences in the individual needs, may be compensated by an appropriate choice of curvature of the sound tube.

In particular when using soft earplugs, the sound tube has to have a stable form, maintaining more or less a predefined curvature from the hearing aid housing to the earplug by itself, thereby aiding in the positioning of the earplug.

Because the length of tube, on which the connection means are placed by insert moulding, is cut from a longer length of tube, it will per se not have the right three-dimensional curvature to suit the user. Rather, to the extent that the length of tube is not straight, it will typically have a two-dimensional curvature reflecting the fact that it was delivered as a coil of tube.

On this background it is the object of the present invention to provide a method and a tool for shaping an elongated member, such as or comprising a sound tube for a hearing aid.

### SUMMARY OF THE INVENTION

According to a first aspect of the present invention this object is achieved by a tool adapted for shaping a sound tube member for a hearing aid, which tool has been manufactured using a rapid prototyping process.

By the use of a rapid prototyping process it is achieved that the elongated member may be shaped individually to the individual characteristics of the ear of the actual user to use the elongated member in connection with e.g. a BTE hearing aid. By this individual shaping, the elongated member may be made to lie closer to the ear, and thus be less conspicuous. Moreover, in addition to the individual shaping of the elongated member to be less conspicuous, the use of a rapid prototyping process allows the tool to be individually shaped, in order to impart the elongated member a curvature that takes up any excessive length not needed. Thus only a few specific standard lengths of elongated members, e.g. three, need to be kept in stock.

According to a second aspect of the invention, the object is achieved by a method for providing a tool for shaping a sound tube member for a hearing aid, wherein the method comprises manufacturing of the tool by means of a rapid prototyping process.

By the use of this tool the elongated member may be shaped individually to the individual characteristics of the ear of the actual user.

According to a third aspect of the invention there is provided a method for shaping a sound tube member for a hearing aid, comprising the steps of placing the first end of the sound tube member in a predetermined position, positioning said intermediate parts of said sound tube member in a predetermined position, placing the second end of the sound tube member in a predetermined position, heating said sound tube member, and cooling said sound tube member.

Thereby it is achieved that the sound tube can be held in a position with a desired curvature for a time long enough for it to set in a desired shape corresponding to this curvature and maintain this shape after cooling.

According to a preferred embodiment of the first aspect of the invention, the tool is made of a plastic material. Plastic is inexpensive, and since the invention does not involve any high temperatures, it has sufficient durability. Moreover, using a plastic material is preferable in that it allows the use of rapid prototyping processes such as stereolithography or selective laser sintering.

Thus, according to a further preferred embodiment, the rapid prototyping process is a stereolithography process. The stereolithography process is itself advantageous in that a high degree of precision in the manufacture of the tool may be achieved. Preferred materials for this are plastic materials selected from the group comprising acryl and epoxy, but in principle any material typically used in this process may be used. If fine details of the tool are needed, epoxy would be preferred.

However, according to another preferred embodiment, the rapid prototyping process is a selective laser sintering process. Compared to stereolithography, selective laser sintering allows the tools to be made more durable. Currently it is preferred to use a plastic material such as a polyamide, but also metals, such as aluminium, or even ceramics could be used.

According to an especially preferred embodiment of the invention, the tool is manufactured on the basis of recorded data concerning an individual's ear. Having once recorded the data concerning the individual's ear, the method according to the invention allows any number of tools to be manufactured, be it locally at the audiologist's, in a remote manufacturing plant, or any other appropriate place without need for sending any physical models. Instead, the data may simply be transmitted over a computer network.

In another embodiment the tool is adapted to shape an elongated object having a predetermined length. This adaptation is facilitated by the use of a rapid prototyping process, and allows a limited number of elongated elements to be kept in stock.

Thus, according to a further embodiment the tool is adapted to shape an elongated object having a length selected among a number of predetermined lengths, said number being larger than one and preferably smaller than four. Thus the number of elongated objects is very limited, e.g. to three, bearing in mind that the elongated elements may be shaped to fit either the right ear or the left ear.

According to another embodiment there is provided a tool for shaping an elongated deformable member for a hearing aid, said tool comprising a first holding means for a first end of the elongated member, a second holding means for holding a second end of the elongated member, wherein the tool comprises positioning means for positioning and holding intermediate parts of said elongated member between said first end and said second end in a fixed desired shape. Such a tool is convenient for shaping the elongated member, but may have a rather complex shape. However, even though the maximum dimensions of the tool will only be a few centimetres, e.g. 4 to 7 centimeters, and has a complex geometry, which is demanding regarding precision, the inventors have realized that the tool is suitable for manufacture using a rapid prototyping process. Thus, despite the small dimensions, the invention nonetheless renders itself for manufacture using a rapid prototyping method.

According to a preferred embodiment, said first holding means comprises means for securing said first end of said elongated member against motion in a direction towards the second end along the longitudinal axis of the elongated member. This is advantageous because during the placing of the elongated member in the tool a pull will be exerted on the elongated member in order to obtain the desired shape.

According to a further preferred embodiment of the tool, the first holding means comprises means for securing said first end of said elongated member against unwanted rotation about the longitudinal axis of the elongated member. This allows one end of the elongated member to be held in place in the tool while the rest of the elongated member is twisted into an overall three dimensional shape.

According to yet a further embodiment, said second holding means comprises means for securing said second end of said elongated member against motion in a direction towards the first end along the longitudinal axis of the elongated member. Thereby it is achieved that both ends of the elongated member are fixed in the positions necessary for matching at one end the housing of the hearing aid when it is attached thereto, whilst the other end is in the correct position with respect to the ear canal.

According to another embodiment of the invention, said tool further comprises a third holding means for holding an auxiliary part of said elongated member in a predetermined position. This allows the normally straight auxiliary part to be given a predetermined shape indicating to the user how it should later be formed into a loop. In particular, the third holding means may comprise a curved groove, in which the straight auxiliary part may be placed.

In a preferred embodiment thereof, the tool further comprises means for securing said auxiliary part in said groove, in particular said means for securing said auxiliary part may comprise a protrusion projecting laterally into said groove from a side wall thereof.

According to a further preferred embodiment, said positioning means comprises at least one protrusion. This allows the elongated member to be wrapped around the protrusions into the desired shape between the holding means at either end of the elongated member.

In particular said protrusion may be undercut, so as to provide a groove for receiving said elongated member. This secures the twisted and bent elongated member laterally, thus aiding in holding the elongated member in the desired position and shape.

In a preferred embodiment of the method according to the invention, said rapid prototyping process is a stereolithography process. As mentioned already, the stereolithography process is precise, and relies on inexpensive materials, in particular a plastic material selected from the group comprising acryl and epoxy.

In an alternative, but also preferred embodiment, said rapid prototyping process is a selective laser sintering process. Compared to stereolithography, selective laser sintering allows the tools to be made more durable. Currently it is preferred to use a plastic material such as a polyamide, but also a metal, such as aluminium, or even a ceramic could be used.

In an especially preferred embodiment of the method according to the invention, said rapid prototyping process involves the use of pre-recorded data about an individual's ear. This allows the individual shaping of the tool to produce an individually shaped elongated element, in particular a sound tube, for the wearer.

According to a further preferred embodiment of the method, the pre-recorded data about the individual's ear are obtained by laser scanning of the ear. This allows a quick and clean establishment of the data, obviating the need for making a cast of the ear, as used in a traditional method.

According to yet another preferred embodiment the data obtained by the laser scanning is transmitted online to a manufacturing facility remote from the location where the scanning takes place. This allows the shaping tools to be manufactured centrally. They may then either be shipped to the audiologist in order for him to use them for shaping the elongated members whenever the user is in need for new ones. Alternatively, the elongated members could also be shaped to the user's individual needs at the central facility, and then be shipped to the audiologist or even directly to the user.

According to a preferred embodiment of the invention, the method further comprises the steps of providing a tool having a first holding means for a first end of the elongated member, a second holding means for holding a second end of the elongated member, and means for positioning and holding intermediate parts of said elongated member between said first end and said second end in a fixed desired shape, placing the first end of the elongated member in the first holding means, placing the intermediate parts of said elongated member in said positioning means for holding the intermediate parts of said elongated member, placing the second end of the tube in the second holding means, heating said elongated member, cooling said elongated member, and removing said elongated member from the tool. Using such a tool not only simplifies the placement of the elongated deformable member in the right position and the right curvature, but also allows this to be done on an individual basis, because the tool may be readily made for a specific individual's needs.

According to a further preferred embodiment, said elongated member is twisted by an angle after said first end thereof has been placed in said first holding means but before said second end has been placed in said second holding means. This allows the elongated member to be manufactured in a simple way using an insert moulding technique.

According to another preferred embodiment, said positioning means comprises a protrusion and the intermediate parts of said elongated member are placed therein by wrapping said elongated member at least partially around said protrusion. This facilitates the positioning of the elongated member in the tool, whilst at the same time allowing the tool to be made of one single piece without any hinged or otherwise movable parts. This again lends itself to the use of a rapid prototyping method for the manufacture thereof.

According to yet a further embodiment of the invention, the method further comprises the step of placing an auxiliary part of said elongated member in a third holding means in said tool. By means of this, the auxiliary part may be given a predetermined curvature indicating to the user how it is going to be used.

In an even further preferred embodiment of the method according to the invention, the elongated member is heated to a temperature of between approximately 90° C. and 120° C. This has been found to be an appropriate temperature to allow the deformable elongated member to set in the predetermined shape, without having to wait too long.

In an especially preferred embodiment, the elongated member is heated in boiling water at atmospheric pressure. Under normal atmospheric pressures the use of boiling water provides an easy way of controlling the temperature, so as to ensure that it is in the above temperature interval.

According to an especially preferred embodiment of the method according to the invention, said deformable elongated member comprises a tube.

### BRIEF DESCRIPTION OF THE DRAWINGS

The invention will now be described in greater detail based on non-limiting exemplary embodiments of the invention illustrated in the drawings. In the drawings,

FIG. 1 shows a BTE hearing aid with an elongated member comprising a sound tube shaped embodying the present invention,

FIG. 2a shows the elongated member before it is shaped,

FIG. 2b shows the elongated member after it is shaped,

FIG. 3a shows a tool embodying the present invention for shaping an elongated member for a hearing aid, as seen in a first angle,

FIG. 3b shows a tool embodying the present invention for shaping an elongated member for a hearing aid, as seen in a second angle,

FIG. 3c shows a tool embodying the present invention for shaping an elongated member for a hearing aid, as seen in a third angle,

FIG. 3d shows a tool embodying the present invention for shaping an elongated member for a hearing aid, as seen in a fourth angle,

FIG. 3e shows a tool embodying the present invention for shaping an elongated member for a hearing aid, as seen in a fifth angle, and

FIG. 3f shows a tool embodying the present invention for shaping an elongated member for a hearing aid, as seen in a sixth angle.

### DETAILED DESCRIPTION OF THE INVENTION

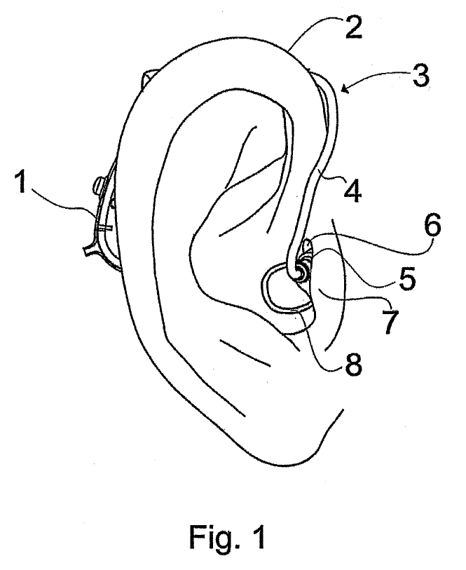

FIG. 1 shows a BTE hearing aid, with the hearing aid housing 1 placed behind an ear 2 of a user. An elongated member 3 comprising a sound tube 4 conducts sound from an output transducer in the hearing aid housing 1 to an earplug 5 attached to the distal end of the elongated member 3 and inserted in the ear canal 6 of the user. The earplug 5 is held in place behind tragus 7, by means of an adjustable loop formed by means of an auxiliary part in the form of a strip 8.

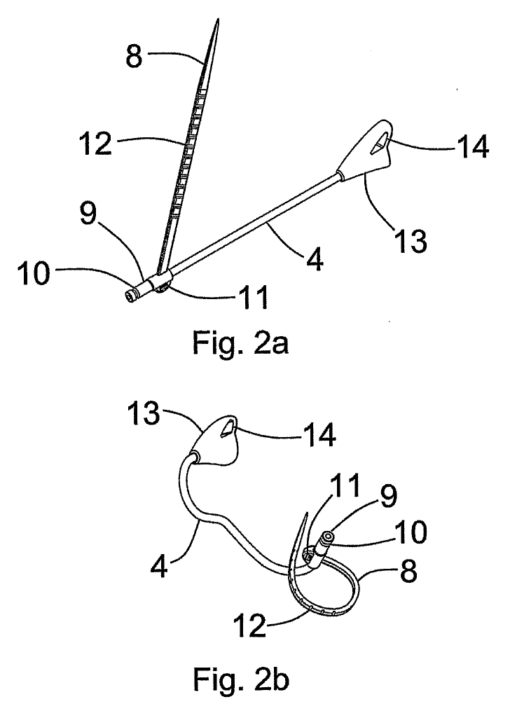

In FIG. 2a, the elongated member 3 is shown in an initial straight condition. The elongated member 3 may have a slight curvature (not shown), stemming from the fact that this part of the elongated member, which is typically a single-lumen sound tube 4, has been manufactured in a separate process, such as extrusion, and cut into a suitable length. Typically the sound tube 4 is made of a transparent plastic material, such as a polyamide type plastic, in order not to make it too conspicuous. Because the sound tube 4 is produced in longer lengths, it will typically be delivered as a coil, and may thus have set with a slight curvature over time at storage temperature.

In the following description it will be assumed that the elongated element comprises a single-lumen sound tube 4, but all considerations would apply equally to multi-lumen sound tubes, or elongated elements comprising electrical conductors.

In the manufacturing process, an appropriate length of sound tube 4 is cut form the longer lengths delivered. Typically only three different lengths are used, because selections among these can accommodate most people's ears. It is currently preferred to use three lengths of tube for adults, namely approximately 52 mm, 56 mm and 59 mm. Once cut the length of sound tube 4 is provided with appropriate attachment means 9, 13 for attaching the resulting elongated member 3 comprising the sound tube 4 to an earplug 6 and the hearing aid housing 1, respectively.

Thus, in the illustrated example one end of the sound tube 4 is provided with a cylindrical earplug attachment means 9, comprising a circumferential recess 10. The earplug attachment means 9 may further comprise the strip 8 and an eyelet 11 for receiving and retaining the strip 8, by means of a number of recesses 12 therein. The strip 8 has recesses 12 on either side thereof allowing it to be inserted and retained in the eyelet 11 from either side thereof, depending on whether the elongated member 3 is to be used for a left or a right ear. Thus, the arrangement of the earplug attachment means 9 and the parts it comprises is generally symmetrical about a plane (not indicated). The other end of the sound tube 4 is provided with hearing aid attachment means 13. The hearing aid attachment means 13 comprises a through passage 14, not intersecting the lumen of the sound tube 4. The cross section of the hearing aid attachment means 13 is slightly oval in order to match the hearing aid housing 1 and make a smooth and aesthetic transition to the sound tube 4. The shape of the oval cross section is so that it generally extends in the direction of the above-mentioned plane, and is symmetrical about this plane.

The reason that the shape of the oval cross section and the strip 8 generally extend in the same plane is because both of the attachment means 9, 13 are normally provided around the ends of the sound tube 4 by means of a single insert moulding process. In this insert moulding process it is convenient to place the longer dimensions along the plane separating two halves of the mould. The attachment means 9, 13 formed in this insert moulding process may also typically be made of a polyamide type plastic, differing, however, from that of which the sound tube 4 is made.

From the generally straight and two-dimensional condition shown in FIG. 2a, the deformable elongated object 3 has to be given a three-dimensional shape, e.g. as shown in FIG. 2b. The shape of the elongated member 3 shown in FIG. 2b is suitable for the right ear, as illustrated in FIG. 1. Since, however, the elongated member is symmetrical in the initial condition shown in FIG. 2a it might just as well have been shaped to fit a left ear. Moreover, the shape illustrated in FIGS. 1 and 2b is only an example, the actual shape would depend on the individual user, in order to allow parts of the elongated member to lie as close as possible to the head of the user, and to be concealed for as great a part as possible behind pinna.

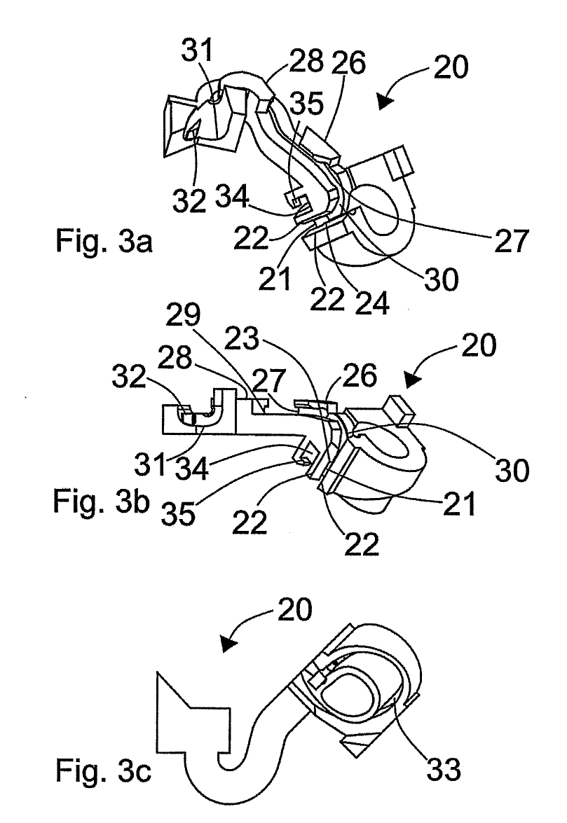

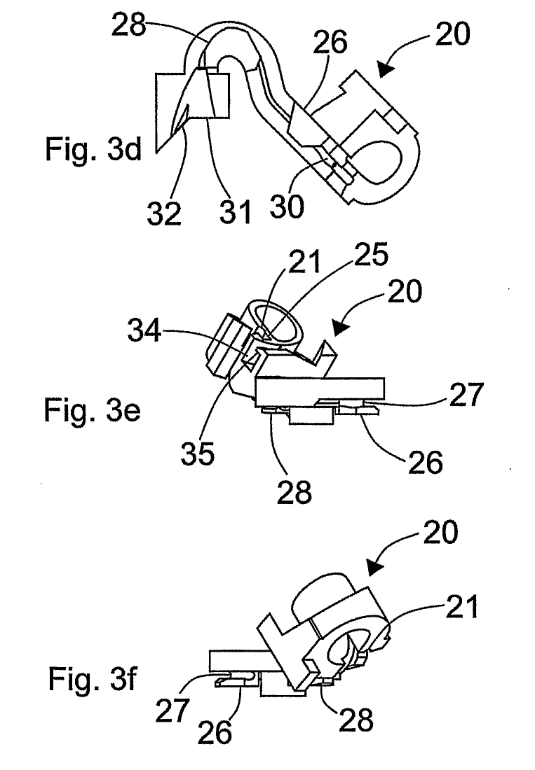

For this, a tool 20 according to the invention is made. In FIGS. 3a to 3f, an exemplary tool 20 corresponding to the shape of the elongated member 3 illustrated in FIG. 2b, is shown. The inventors have realised that for the specific purpose of shaping the elongated member 3 of a hearing aid, a tool 20 manufactured in a rapid prototyping process has sufficient strength and durability, even if the rapid prototyping process is one, such as stereolithography or selective laser sintering, using a plastic material. The tool 20 is thus manufactured using a rapid prototyping process. Apart from those mentioned above, there are a number of different rapid prototyping processes, by which the tool 20 according to the invention may be manufactured. It is, however, currently preferred to use stereolithography because it has a high degree of precision, but selective laser sintering could also be used. Typical materials, which may be used for stereolithography in this context, are acryl and epoxy. For selective laser sintering, a polyamide could be used.

Using the rapid prototyping processes mentioned above allows a tool 20 to be manufactured specifically to shape the elongated member 3 to a fit matching exactly the specific dimensions and shapes of an individual's ear 2. Thus, the elongated members 3 may be shaped in such a way that their appearance is as discrete as possible when placed in the user's ear 2.

For this the necessary data regarding the user's ear are recorded. This may be done directly by laser scanning of the user's ear 2, or it may be done indirectly based on a cast of the user's ear 2, which is then scanned.

This laser scanning may be performed directly at the audiologist's or it may be done remotely in a production facility. If done at the audiologist's, the resulting data about the user's ear 2 may be transmitted to a remote production facility where the tool 20 is produced by means of said rapid prototyping process, based on said data. The tool 20, or several copies thereof, may then be shipped back to the audiologist's in order to allow him to shape elongated members 3 for the user upon his request. Alternatively, the audiologist may order a number of shaped elongated members 3 from a supplier, who would shape them with the tool 20 produced in the remote production facility.

Irrespective of where said shaping of the elongated member 3 takes place, the elongated member 3 would be placed in the tool 20, heated and cooled in order to obtain the desired, predetermined shape, and then removed from the tool 20, which may then be reused. In order to obtain the desired shape, the elongated member 3 will normally be heated in an oven to a temperature between 90° C. and 120° C. for a period of e.g. 4 minutes or less, depending on the oven type used, and then be cooled down again to normal room temperature or less before removal from the shaping tool 20. If this process is performed by the audiologist, it may conveniently be performed by means of heating in boiling water and subsequent cooling in cold tap water. In this case, the heating period would be shorter, e.g. less than 30 seconds.

These temperature values and times would also apply if a shaping tool in the form of a deformable wire is used, the wire being inserted into the lumen of the elongated member. The wire and elongated member will then be suitably deformed, heated, and cooled, before extraction of the deformable wire.

The details of an exemplary tool 20 for shaping a deformable elongated object according to the invention will now be explained based on FIGS. 3a to 3f, showing the tool 20 from different angles.

As best seen in FIGS. 3a, 3b, 3e and 3f, the tool comprises a first holding means in the form of a generally cylindrical hole 21 for receiving a first end of the elongated member 3 comprising the generally cylindrical earplug attachment means 9. The cylindrical hole 21 has a longitudinal slit defined by edges 22, allowing the narrow part, i.e. the sound tube 4, of the elongated member 3 to be inserted sideways into the cylindrical hole 21. When the tube has been inserted in the cylindrical hole 21, the cylindrical earplug attachment means 9 may be pulled into the cylindrical hole along the axis thereof, until it abuts a shoulder 23 forming the transition to a narrower cylindrical part 24 having a diameter corresponding essentially to the external diameter of the sound tube 4. The shoulder 23 thus secures the position of the elongated member 3 in a direction along the longitudinal axis thereof. As can best be seen from FIG. 3e, a recess 25 is formed in the side wall of the cylindrical hole 21. When the earplug attachment means 9 is pulled into the cylindrical hole 21, the recess 25 will receive the part in which the eyelet 11 is provided and secure the earplug attachment means 9 against rotation.

Thus secured, the elongated member may be twisted by an angle and placed in the positioning means. The actual angle will depend on the actual user's need, but would typically be approximately 90°. The positioning means comprises a first protrusion 26 having an undercut 27 and a second protrusion 28 having an undercut 29. The elongated member 3 is placed in the positioning means by being wrapped slightly around the first protrusion 26 and around the second protrusion 28, where it is in either case held laterally in the respective undercuts 27 or 29. The positioning means may further comprise a groove 30 in the transition between the narrower cylindrical part 24 and the undercut 27 under the first protrusion 26.

Following this, the hearing aid attachment means 13 is placed in a second holding means. The second holding means comprises a shallow recess 31 corresponding to the shape of either side of the hearing aid attachment means 13. Moreover the shallow recess 31 has a raised part or protrusion 32, adapted to engage the through passage 14 in the hearing aid attachment means 13. The engagement between the protrusion 32 and the passage 14 helps securing the hearing aid attachment means 13 laterally and longitudinally in the shallow recess 31.

The tool 20 furthermore comprises a third holding means for holding the strip 8. The third holding means comprises a curved groove 33. When the earplug attachment means 9 is placed in the cylindrical hole 21 with the protrusion comprising the eyelet 11 in place in the recess 25, the strip 8 will extend in a direction tangential to the groove 33. The strip may now be placed in the groove 33 so as to be tensioned against the outer wall thereof and protruding from the opening 34. It is held in place in the groove 34 by means of a protrusion 35, under which it is slipped when placed in the groove 34.

The strip 8 will thus also gain a predetermined shape when exposed to the heating and cooling treatment of the invention. This predetermined shape will indicate to the user, from which direction the strip 8 is to be introduced in the eyelet 11, in order to form an appropriate loop, as seen in FIG. 1.

It should be noted that the above description of the invention has been given as examples. The skilled person will understand that numerous possible variations exist within the scope of the claims. Thus, the skilled person will know that e.g. the temperature ranges mentioned will depend on the actual materials from which the elongated member 3 is made and the time accepted for the material to set in the desired shape. Also, the materials selected for the tool 20 are preferred materials only. The skilled person will know that any material used in a rapid prototyping process, which is sufficiently durable to withstand the temperatures used in the shaping process may be suitable.

We claim:

1. A tool adapted for shaping a sound tube member for a hearing aid, which tool has been manufactured using a rapid prototyping process.

2. The tool according to claim 1, which tool is made of a plastic material.

3. The tool according to claim 1, wherein the rapid prototyping process is a stereolithography process.

4. The tool according to claim 1, which tool is made of a material selected from the group comprising acryl, epoxy and polyamide.

5. The tool according claim 1, wherein the rapid prototyping process is a selective laser sintering process.

6. The tool according to claim 1, which tool has been manufactured on the basis of recorded data concerning an individual's ear.

7. The tool according to claim 1, which tool is adapted to shape an elongated object having a predetermined length.

8. The tool according to claim 1, which tool is adapted to shape an elongated object having a length selected among a number of predetermined lengths, said number being larger than one and preferably smaller than four.

9. A tool adapted for shaping a sound tube member for a hearing aid, said tool comprising a first holding means for a first end of the sound tube member, a second holding means for holding a second end of the sound tube member, and positioning means for positioning and holding a part of said sound tube member intermediate said first end and said second end in a fixed desired shape.

10. The tool according to claim 9, wherein said first holding means comprises means for securing said first end against motion in a direction towards said second end along the longitudinal axis of the sound tube member.

11. The tool according to claim 9, wherein said first holding means comprises means for securing said first end of the sound tube member against rotation about the longitudinal axis of the sound tube member.

12. The tool according to claim 9, wherein said second holding means comprises means for securing said second end against motion in a direction towards said first end along the longitudinal axis of the sound tube member.

13. The tool according to claim 9, comprising a third holding means for holding an auxiliary part of the sound tube member in a predetermined position.

14. The tool according to claim 13, wherein said third holding means comprises a curved groove.

15. The tool according to claim 14, comprising means for securing said auxiliary part in said groove.

16. The tool according to claim 15, wherein said means for securing said auxiliary part comprises a protrusion projecting laterally into said groove from a side wall thereof.

17. The tool according to claim 9, wherein said positioning means comprises at least one protrusion.

18. The tool according to claim 17, wherein said protrusion is undercut, so as to provide a groove for receiving the sound tube member.

19. A method for providing a tool for shaping a sound tube member for a hearing aid, comprising manufacturing the tool by means of a rapid prototyping process.

20. The method according to claim 19, wherein said rapid prototyping process is a stereo lithography process.

21. The method according to claim 19, comprising manufacturing the tool of a plastic material selected from the group comprising acryl, epoxy and polyamide.

22. The method according to claim 19, wherein said rapid prototyping process is a selective laser sintering process.

23. The method according to claim 19, wherein said rapid prototyping process involves the use of pre-recorded data about an individual's ear.

24. The method according to claim 23, wherein the pre-recorded data about the individual's ear are obtained by laser scanning of the ear.

25. The method according to claim 24, wherein the data obtained by the laser scanning are transmitted online to a manufacturing facility remote from the location where the scanning takes place.

26. A method for shaping a sound tube member for a hearing aid, said method comprising the steps of placing a first end of the sound tube member in a first predetermined position, placing a second end of the sound tube member in a second predetermined position, positioning a part of the sound tube member intermediate said first end and said second end in a third predetermined position, heating the sound tube member, and cooling the sound tube member.

27. A method for shaping a sound tube for a hearing aid, said method comprising the steps of
providing a tool having a first holding means for a first end of the sound tube, a second holding means for holding a second end of the sound tube, and positioning means for positioning and holding a part of the sound tube intermediate said first end and said second end in a fixed desired shape, placing said first end in the first holding means, placing said second end in the second holding means, placing the intermediate part in said positioning means, heating the sound tube, cooling the sound tube, and removing the sound tube from the tool.

28. The method according to claim 27, comprising twisting the sound tube by an angle after said first end has been placed in said first holding means and before said second end has been placed in said second holding means.

29. The method according to claim 27, wherein said positioning means comprises a protrusion, and wherein the step of placing the intermediate part in the positioning means comprises wrapping said sound tube at least partially around said protrusion.

30. The method according to claim 27, comprising the step of placing an auxiliary part of the sound tube in third holding means in said tool.

31. The method according to claim 27, wherein the step of heating the sound tube comprises heating the sound tube to a temperature of between 90° C. and 120° C.

32. The method according to claim 31, wherein the sound tube is heated in boiling water at atmospheric pressure.

33. The method according to claim 27, wherein the sound tube object has a predetermined length.

34. The method according to claim 33, wherein the sound tube has a length selected among a number of predetermined lengths, said number being larger than one and preferably smaller than four.

35. The method according to claim 27, wherein said sound tube comprises a deformable tube.

36. A sound tube member for a hearing aid comprising an electrical conductor and shaped by way of placing a first end of the sound tube member in a first predetermined position, placing a second end of the sound tube member in a second predetermined position, positioning a part of the sound tube member intermediate said first end and said second end in a third predetermined position, heating the sound tube member, and cooling the sound tube member.
